(19) United States
(12) Patent Application Publication
(10) Pub. No.: US 2009/0236350 A1
(43) Pub. Date: Sep. 24, 2009

(54) VENTILATING DEVICE FOR FUEL TANK

(75) Inventor: Natsushi MIURA, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/404,478

(22) Filed: Mar. 16, 2009

(30) Foreign Application Priority Data
Mar. 19, 2008 (JP) 2008-71046

(51) Int. Cl. B65D 90/22; F16K 31/18; B60K 15/035

(52) U.S. Cl. 220/745; 137/409; 137/43

(57) ABSTRACT

The fuel tank ventilating device includes a fuel cutoff device, and a connector pipe connecting the fuel cutoff device with a canister. The fuel cutoff device includes a first fuel cutoff valve, a second fuel cutoff valve, and a positive pressure valve; the first flow pipe and the second flow pipe are connected to a third flow pipe by a connecting part, and are connected to the canister. With the first fuel cutoff valve in a first submersion state, fuel that has collected in the first flow pipe will be returned to the fuel tank on the basis of a differential pressure between tank internal pressure and the pipe internal pressure bearing on the fuel inside the first flow pipe. With the first fuel cutoff valve in a submersion state, fuel that has leaked into the second flow pipe will not reach the connecting part.

This application claims the benefit of and priority from Japanese Application No. 2008-71046 filed Mar. 19, 2008, the content of which is incorporated herein by reference.

### BACKGROUND OF THE INVENTION

1. Field of the Invention

The present invention relates to a ventilating device for a fuel tank, adapted to prevent fuel from spilling from the fuel tank to the outside.

2. Description of the Related Art

One known technology proposed for a fuel tank ventilating device of this kind is that disclosed in JP-A 2005-172161, for example. Specifically, the fuel tank ventilating device is provided with a fuel cutoff valve (rollover valve) and a full tank regulating valve connected to a canister, these being disposed in the upper part of the fuel tank; through appropriate opening and closing of the valves at prescribed fuel levels, venting of the fuel tank to the outside may be assured while at the same time preventing the liquid fuel from spilling to the outside. Despite enhanced sealing ability provided by a valve body of rubber or the like, the fuel cutoff valve in the closed state will not be able to prevent outflow of fuel to the canister, and slight leakage will occur. In order to prevent leaking fuel from reaching the canister, means such as extending the length of the pipe, situating a section of the pipe at an elevated location, or employing a vapor-liquid separating device have been employed.

However, a problem with such means is the complexity of design entailed with complicated and elongated piping arrangement, or with a piping arrangement having elevated section produced through a bending process.

### SUMMARY

An advantage of some aspects of the invention is to provide with a fuel tank ventilating device of simple design, that does not require a complicated and elongated piping arrangement or a piping arrangement having an elevated section produced through a bending process.

The present invention is addressed to attaining the above objects at least in part according to the following modes of the invention.

A first mode of the present invention provides a fuel tank ventilating device comprising: a fuel cutoff device for opening and closing a passage to a canister according to fuel level in a fuel tank; and a connector pipe connecting the fuel cutoff device with the canister. The fuel cutoff device includes: (i) a first fuel cutoff valve adapted to open and close a first connecting passage through rise and fall of a first float mechanism according to the fuel level in the fuel tank; (ii) a second fuel cutoff valve adapted to open and close a second connecting passage through rise and fall of a second float mechanism according to the fuel level in the fuel tank; and (ii) a positive pressure valve connected to the second connecting passage and adapted to open when tank internal pressure rises above a prescribed valve opening pressure, wherein the first and second fuel cutoff valves are arranged to have a first submersion state and second submersion state when the fuel tank are oriented at a tilted position between a first maximum tilt angle and a second maximum tilt angle representing reverse maximum tilts respectively. The first submersion state is a state in which the first fuel cutoff valve is submerged and the second fuel cutoff valve communicates a headspace of the fuel tank with the canister, and the second submersion state is a state in which the second fuel cutoff valve is submerged and the first fuel cutoff valve communicates the headspace of the fuel tank with the canister. The connector pipe includes: (i) a first flow pipe connected to the first connecting passage; (ii) a second flow pipe connected to the second connecting passage via the positive pressure valve and connected to the first flow pipe by a connecting part; and (iii) a third flow pipe connecting the connecting part with the canister. The fuel tank ventilating device is configured such that when in the first submersion state, fuel that has flowed out from the fuel tank into the first flow pipe via the first fuel cutoff valve, the fuel is returned to the fuel tank by a differential pressure between a first pressure and a second pressure, the first pressure being a tank internal pressure which has been regulated to a level at or below the prescribed valve opening pressure of the positive pressure valve, the second pressure being a pipe internal pressure bearing on the fuel inside the first flow pipe; and when in the second submersion state and at the second maximum tilt angle, fuel that has leaked from the fuel tank into the second flow pipe via the second fuel cutoff valve, the fuel does not reach the connecting part.

According the fuel tank ventilating device taught in this first mode, even where the vehicle has a full tank and has assumed a condition tilted as far as either the first or second maximum tilt angle, either the first fuel cutoff valve or the second fuel cutoff valve will open to ensure venting of the fuel tank to the outside.

One means for preventing outflow of fuel to the canister through the second flow pipe in the second submersion state with the second fuel cutoff valve submerged would be to dispose the connecting part at a location whereby the second flow pipe is longer than the first flow pipe, rather than the first flow pipe and the second flow pipe being of equal length. With this arrangement, even if the first flow pipe and the second flow pipe are routed on the horizontal, if the fuel tank should tilt, to the extent that the second flow pipe is longer it will be easier for the connecting part to be positioned above the fuel level in the fuel tank, that is, it will be easier to produce a pipe arrangement that inhibits outflow of fuel to the canister. Consequently, there will be no need for a complicated and elongated line or a line having an elevated section produced through a bending process as described in the prior art, thus affording a simpler design.

An arrangement whereby the connecting part is situated at a location such that the first flow pipe is shorter than the second flow pipe will make it more difficult, owing to the short length of the first flow pipe, for the connecting part to be situated at a high position when the tank is tilted, and will make it easier for leaked fuel to reach the connecting part where the first fuel cutoff valve is submerged; however, means such as the following can be adopted to avoid such problems. Specifically, firstly, the sealing ability of the first fuel cutoff valve may be enhanced to reduce the amount of fuel leakage; and secondly, there may be employed means adapted to return fuel that has collected in the first flow pipe back to the fuel tank by utilizing a differential pressure arising between pipe internal pressure in the first flow pipe versus the tank internal pressure, caused by cyclical negative pressure of the tank internal pressure. Such avoidance means will be simple in design, as it involves merely improving sealing ability of the first fuel cutoff valve used conventionally.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows a fuel tank having an installed fuel tank ventilation device according to an embodiment of the present invention;

FIG. 2 is a sectional view depicting a first fuel cutoff valve;

FIG. 3 is a sectional view depicting a fuel cutoff valve in exploded view;

FIG. 4 is a cross sectional view depicting a second fuel cutoff valve;

FIG. 5 is an enlarged cross sectional view depicting the vicinity of a pressure regulating valve mechanism;

FIG. 6 is a sectional view depicting a positive/negative pressure valve;

FIG. 7 shows the operation of the fuel tank ventilating device in a first submersion state;

FIG. 8 shows the operation of the fuel tank ventilating device in a second submersion state; and

FIG. 9 shows a fuel tank having an installed fuel tank ventilation device according to another embodiment of the present invention.

### DESCRIPTION OF THE PREFERRED EMBODIMENTS

### (1) Overall Configuration of Fuel Tank Ventilating Device

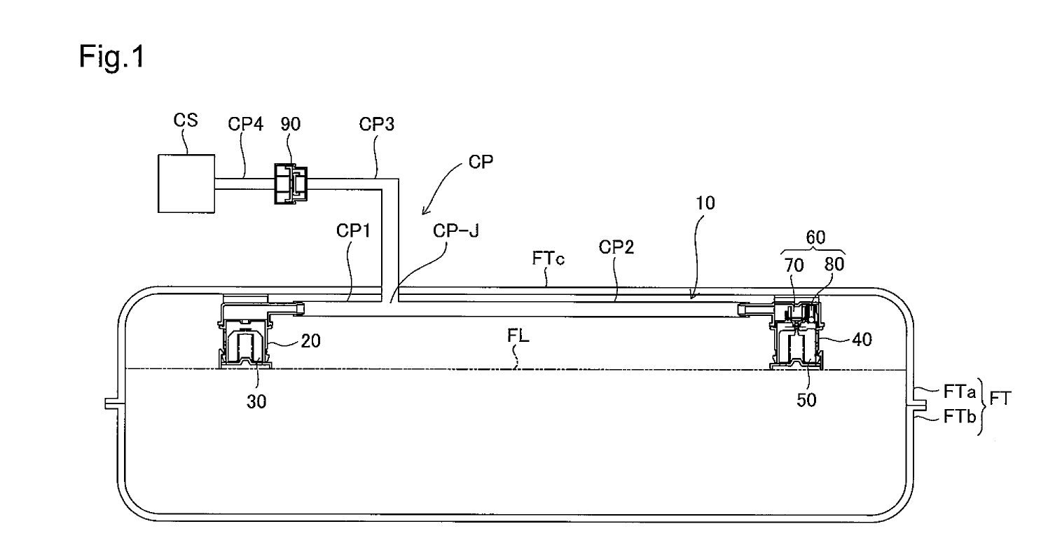

FIG. 1 is an illustration depicting a fuel tank FT having an installed fuel tank ventilation device according to an embodiment of the present invention. The fuel tank FT is a flattened tank adapted to ensure a roomy passenger cabin in the vehicle, and is formed split into two parts, an upper half part FTa and a lower half part FTb which are joined together. The fuel tank ventilation device is disposed on the lower wall FTc and to the upper of the fuel tank FT. The fuel tank ventilation device has a fuel cutoff device 10; a connecting pipe CP that connects the fuel cutoff device 10 to a canister CN; and a positive/negative pressure valve 90. The fuel cutoff device 10 also includes a first fuel cutoff valve 20 and a second fuel cutoff valve 40 respectively situated to either side of the upper section of the fuel tank FT. The first fuel cutoff valve 20 and the second fuel cutoff valve 40 ensure venting of the fuel tank FT to the outside, as well as preventing fuel from spilling to the outside in the event that the vehicle tilts.

The connecting pipe CP includes a first flow pipe CP1 that connects with the first fuel cutoff valve 20; a second flow pipe CP2 that connects with the second fuel cutoff valve 40 via a positive pressure valve 70 and that connects with the first flow pipe CP1 by a connecting part CP-J; a third flow pipe CP3 that connects the connecting part CP-J and the positive/negative pressure valve 90; and a fourth flow pipe CP4 that connects the positive/negative pressure valve 90 and the canister CS. The connecting part CP-J is disposed at a location whereby the second flow pipe CP2 is longer than the first flow pipe CPU1, rather than the first flow pipe CP1 and the second flow pipe CP2 being of equal length. The arrangements of the various parts of the fuel tank ventilation device will be discussed below.

### (2) First Fuel Cutoff Valve 20

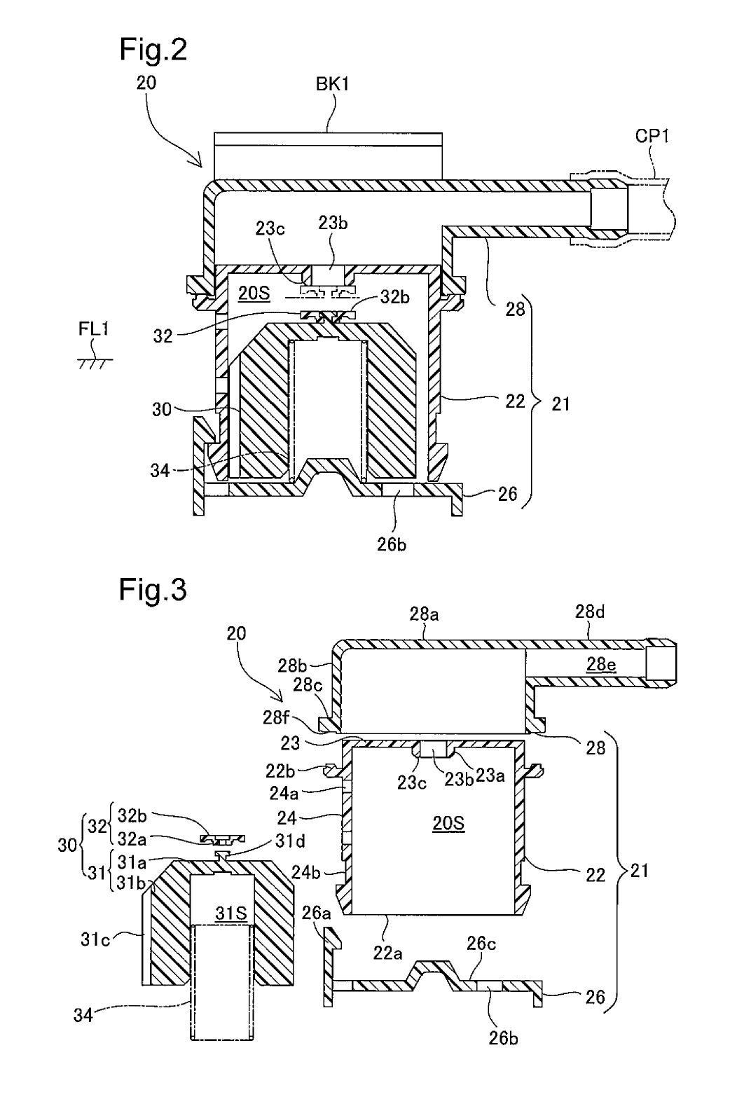

FIG. 2 is a sectional view depicting the first fuel cutoff valve 20. The first fuel cutoff valve 20 includes a casing 21; a first float mechanism 30 housed in a valve chamber 20S inside the casing 21; and a spring 34. The first fuel cutoff valve 20 is attached to the upper wall of the fuel tank FT via a mounting bracket BK1.

(2)-1 Casing 21

FIG. 3 is a sectional view depicting the fuel cutoff valve in exploded view. In FIG. 3, the casing 21 has a main casing body 22; a base plate 26 installed at the bottom of the main casing body 22; and a cover 28 installed at the top of the main casing body 22. The main casing body 22 includes an upper wall 23; and a side wall 24 of round tubular contours that extends downward from the outside peripheral edge of the upper wall 23, thereby defining a cup-shaped valve chamber 20S that is enclosed by the upper wall 23 and the side wall 24 and whose bottom constitutes a lower opening 22a. A float passageway-defining projection 23a is formed in the center of the upper wall 23 and projects downward therefrom. The float passageway-defining projection 23a is perforated by a first connecting passage 23b; and the first connecting passage 23b on the valve chamber 20S thereof constitutes a float seal part 23c. A vent hole 24a that connects the fuel tank FT interior with the valve chamber 20S is formed in the upper part of the side wall 24, and a mating recess 24b is formed in the lower part. The mating recess 24b is employed for attaching the base plate 26.

The base plate 26 is a member adapted to close off the lower opening 22a of the main casing body 22, and is attached so as to provide closure to the lower opening 22a of the main casing body 22 through engagement of a mating hook 26a formed at its outside edge mating recess 24b within the mating recess 24b. The base plate 26 is perforated by a through-hole 26b. A spring support part 26c adapted to support the lower end of the spring 34 is formed on the upper face of the base plate 26.

The cover 28 includes an upper wall 28a of circular disk shape; a side wall 28b of round tubular contours that projects downward from the outside peripheral part of the upper wall 28a; and a flange portion 28c that extends peripherally outward from the lower part of the side wall 28b. A sideward-projecting pipe body 28d is formed on the side wall 28b of the cover 28. A pipe passage 28e is defined inside the pipe body 28d; this pipe passage 28e connects at a first end to the valve chamber 20S via the first connecting passage 23b, and at its other end to the canister. A cover-side welding part 28f is formed on the lower face of the flange portion 28c of the cover 28. The cover-side welding part 28f is attached through laser welding or the like to an annular welding part 22b of the casing 21.

(2)-2 First Float Mechanism 30

The first float mechanism 30 includes a float 31, and an upper part valve body 32 made of rubber situated in the upper part of the float 31. The float 31 is designed with receptacle shape having an upper wall 31a and a tubular side wall 31b formed to the lower side from the outside periphery of the upper wall 31a; its interior space functions as a buoyancy chamber 31S for producing buoyancy. Guide ribs 32 are formed on the outside peripheral part of the float 31. The guide ribs 31c have rib contours and project in the vertical direction at eight equidistant locations in the circumferential direction from the side wall of the float 31. The float 31 is supported on the spring 34 by the spring support part 26c of the base plate 26. The upper part valve body 32 is a valve body made of rubber and including a mounting part 32a adapted to be supported on a valve support portion 31d that projects up from the center of the upper wall 31a, specifically, by being pressure-fit onto the valve support portion 31d; and a seal part 32b of circular disk shape formed from the upper part of the mounting part 32a. The seal part 32b is adapted to deflect when seated in the float seal part 23c so as to exhibit good sealing ability. The spring 34 is positioned inside the buoyancy chamber 31S, and is adapted to urge the float 31 upward by being interposed between one end of the float 31 and the spring support part 26c of the base plate 26.

(2)-3 Operation of the First Float Mechanism 30

As depicted in FIG. 2, if the fuel level in the fuel tank FT should reach a prescribed level FL1 due to tilting or rocking motion of the vehicle, fuel will inflow to the valve chamber 20S through the through-hole 26b in the base plate 26. Accordingly, the first float mechanism 30 will give rise to buoyancy and ascend (shown by double dot-and-dashed lines), with the seal part 32b of the upper part valve body 32 of the first float mechanism 30 becoming seated in the float seal part 23c and blocking off the first connecting passage 23b so that fuel does not flow out to the canister. At this point, the seal part 32b of the upper part valve body 32 will undergo deflection when it seats in the float seal part 23c so as to attain good sealing ability.

### (3) Second Fuel Cutoff Valve 40

(3)-1 General Arrangement of Second Fuel Cutoff Valve 40

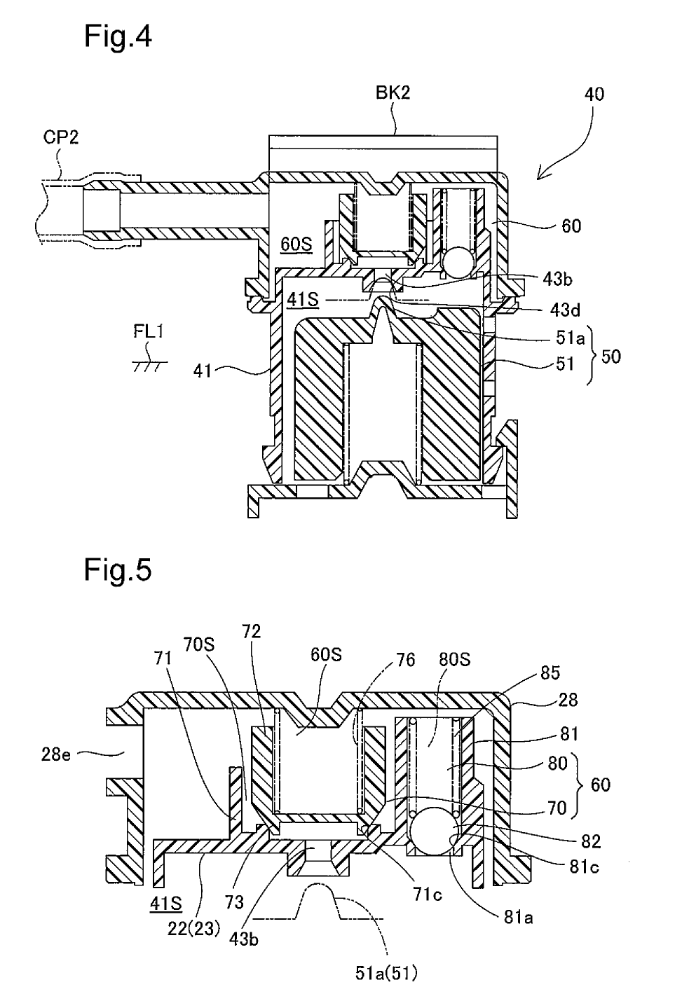

FIG. 4 is a cross sectional view depicting the second fuel cutoff valve 40. The second fuel cutoff valve 40 is substantially identical in design to the first fuel cutoff valve 20 in respect of being adapted to shut at the prescribed level FL1; however, it differs in design in that an additional sealing mechanism and pressure regulating valve mechanism 60 are provided. Specifically, the second fuel cutoff valve 40 includes a casing 41; and a second float mechanism 50 and a pressure regulating valve mechanism 60 which are respectively housed in a valve chamber 41S inside the casing 41 and in an upper valve chamber 60S. The second float mechanism 40 includes a valve part 51a of substantially conical shape projecting up from the upper part of the float 51. The valve part 51a is designed to contact with or release from a float seal part 43d in association with ascent or descent of the second float mechanism 50, thereby opening or closing a second connecting passage 43b. Because the valve part 51a is made of resin, its sealing ability will be somewhat inferior to that of the upper part valve body 32 of the first fuel cutoff valve 20.

(3)-2 Pressure Regulating Valve Mechanism 60

FIG. 5 is an enlarged cross sectional view depicting the vicinity of the pressure regulating valve mechanism 60. The pressure regulating valve mechanism 60 includes the positive pressure valve 70 and a relief valve 80, which are housed within the upper valve chamber 60S. The positive pressure valve 70 is a valve adapted to open when internal pressure in the fuel tank has exceeded a prescribed valve opening pressure Pp, and includes a first passageway-defining projection 71 of round tubular shape projecting from the top center part of the upper wall 23 of the main casing body 22. The first passageway-defining projection 71 defines a first pressure regulating valve chamber 70S that connects the inner space to the second connecting passage 43b. A first pressure regulating valve seal portion 71c facing into the second connecting passage 43b is formed on the upper part of the upper wall 23.

The positive pressure valve 70 includes a first pressure regulating valve body 72 that is urged in the closed direction by the spring 76. A valve part 73 is formed in the lower part of the first pressure regulating valve body 72. The valve part 73 alternately contacts or separates from the first pressure regulating valve seal portion 71c to open or close the second connecting passage 43b. With this design of the positive pressure valve 70, when upward force bearing on the valve part 73 due to pressure through the second connecting passage 43b overcomes the urging force of the spring 76 and the weight of the first pressure regulating valve body 72, the first pressure regulating valve body 72 will move upward and the second connecting passage 43b will open, whereby fuel vapors in the fuel tank may communicate with the canister via the valve chamber 41S, the second connecting passage 43b, the first pressure regulating valve chamber 70S, the upper valve chamber 60S, and the pipe passage 28e.

The relief valve 80 is a valve adapted to reduce pressure inside the fuel tank by opening when the tank internal pressure exceeds a pressure value higher than a prescribed valve opening pressure Pp for the relief valve 80; it includes a second passageway-defining projection 81 of round tubular shape, a second pressure regulating valve body 82, and a spring 85. The second passageway-defining projection 81 defines a second pressure regulating valve chamber 80S that connects the inner space to the valve chamber 41S via a relief passage 81a. A second pressure regulating valve seal portion 81c is formed facing into the relief passage 81a. The second pressure regulating valve body 82 is a ball valve. With this design of the relief valve 80, when upward force bearing on the second pressure regulating valve body 82 due to pressure through the relief passage 81a overcomes the urging force of the spring 85 and the weight of the second pressure regulating valve body 82, the second pressure regulating valve body 82 will move upward and the relief passage 81a will open, whereby the interior of the fuel tank may communicate with the canister via the valve chamber 41S, the relief passage 81a, the second pressure regulating valve chamber 80S, and the upper valve chamber 60S, etc.

### (4) Positive/Negative Pressure Valve 90

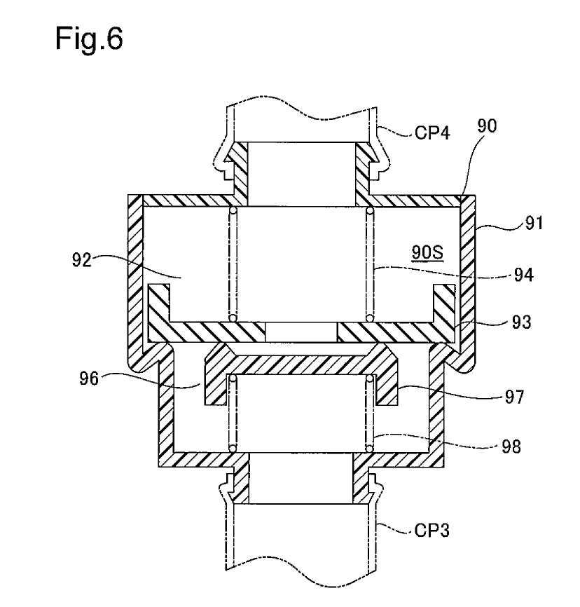

FIG. 6 is a sectional view depicting the positive/negative pressure valve 90. The positive/negative pressure valve 90 connects to the third flow pipe CP3 and to the fourth flow pipe CP4 of the canister CS (see FIG. 1), and is composed of a positive pressure valve 92 and a negative pressure valve 96 which are housed within a valve chamber 90S of a casing 91. The positive pressure valve 92 includes a positive pressure valve body 93, and a coil spring 94 adapted to urge the positive pressure valve body 93. Meanwhile, the negative pressure valve 96 includes a negative pressure valve body 97 and a coil spring 98. Adjustment of pressure inside the fuel tank by the positive pressure valve 92 and the negative pressure valve 96 takes place through the following operation. As pressure in the third flow pipe CP3 increases to the point that the differential pressure bearing on the positive pressure valve body 93 of the positive pressure valve 92 goes above a prescribed pressure, the positive pressure valve body 93 will move upward in opposition to the urging force of the coil spring 94 and the positive pressure valve 92 will open. On the other hand, if tank pressure drops to the point that the differential pressure bearing on the negative pressure valve body 97 of the negative pressure valve 96 goes above a prescribed pressure, the negative pressure valve body 97 will move downward and the negative pressure valve 96 will open. That is, when the pressure in the third flow pipe CP3 goes to positive pressure or negative pressure with respect to atmospheric pressure, and the value thereof has reached or exceeded a prescribed pressure, the positive pressure valve 92 and the negative pressure valve 96 will open and adjust the pressure to within a prescribed range with respect to atmospheric pressure.

### (5) Operation of Fuel Tank Ventilating Device

(5)-1 Operation of Fuel Tank Ventilating Device with Vehicle in a Horizontal Attitude

As depicted in FIG. 1, with the vehicle in a horizontal attitude and the fuel tank FT in a horizontal attitude, neither the first fuel cutoff valve 20 nor the second fuel cutoff valve 40 are submerged. At this time, through rise and fall of the first float mechanism 30 of the first fuel cutoff valve 20 according to the fuel level FL in the fuel tank FT, venting of the fuel tank FT to the canister CS or shutoff thereof will be assured. Here, even if the second fuel cutoff valve 40 is in the open state, the positive pressure valve 70 will not open as long as the prescribed pressure Pp is not exceeded, and thus venting to the canister CS through the second flow pipe CP2 will not take place. The positive pressure valve 70 opens when tank internal pressure reaches the prescribed pressure Pp, while the relief valve 80 functions as an emergency escape valve that opens when the tank internal pressure exceeds the prescribed pressure Pp by a sufficiently large extent.

(5)-2 Operation of Fuel Tank Ventilating Device with Vehicle in a Tilted Attitude

(a) First Submersion State

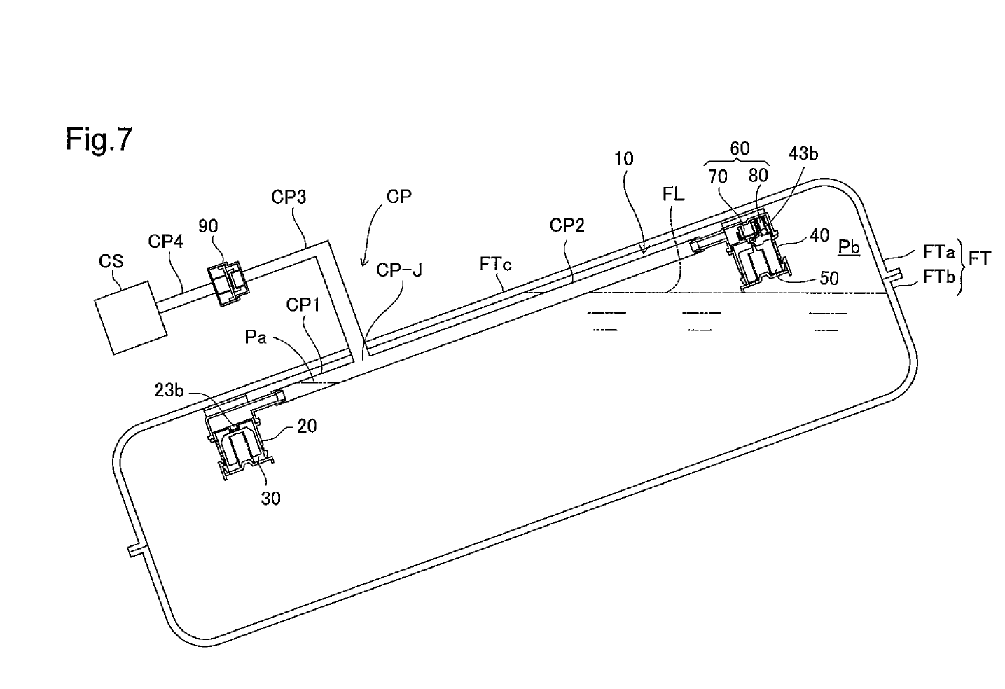

Let it be assumed that the vehicle is at a stop in a titled attitude, with the wheels on one side driven up over the curb for example. In this instance, the fuel tank ventilation device is adapted to prevent fuel from spilling to the outside at the angle of tilt of the fuel tank FT lying between a first maximum tilt angle and a second maximum tilt angle that represent maximums, namely, between −20° and 20°. FIG. 7 depicts a first submersion state in which the first fuel cutoff valve 20 is submerged, while the head space of the fuel tank FT communicates with the canister CS through the second fuel cutoff valve 40. At this time, the first fuel cutoff valve 20 will be situated at a position lower than the first flow pipe CP1 and the second flow pipe CP2. In this first submersion state, since the fuel level FL in proximity to the first fuel cutoff valve 20 exceeds the prescribed level FL1 (see FIG. 2), the first float mechanism 30 will be in the uplifted position, closing off the first connecting passage 23b. In this instance, since the first float mechanism 30 employs the upper part valve body 32 made of rubber (FIG. 3), it will be difficult for fuel to leak; however, even if there is slight leakage into the first flow pipe CP1, this will not reach the connecting part CP-J. On the other hand, since the fuel level in proximity to the second fuel cutoff valve 40 does not exceed the prescribed level FL1 (FIG. 4), the second float mechanism 50 will be in the descended position and the second connecting passage 43b will be open. In this case, owing to its connection to the positive pressure valve 70, the second connecting passage 43b will open when the positive pressure valve 70 has exceeded the prescribed pressure Pp. Since the prescribed pressure Pp has been set to a small value, venting of the fuel tank FT to the canister CS will be assured even where tank pressure is only slightly positive pressure.

In the first submersion state, in the event that the temperature in the vicinity of the fuel tank FT has dropped, fuel vapors inside the fuel tank FT will become liquid and the tank internal pressure will go to negative pressure. In the event that the tank internal pressure goes to negative pressure in this way, the positive pressure valve 70 will shut; and moreover because the pipe internal pressure Pa in the first flow pipe CP1 is being maintained at a higher level by the positive/negative pressure valve 90, a differential pressure will arise between internal pressure Pa in the first flow pipe CP1 and the tank internal pressure Pb. This differential pressure will bear on the fuel that has collected in the first flow pipe CP1 and in such a way as to push down the first float mechanism 30 of the first fuel cutoff valve 20, to slightly open the first fuel cutoff valve 20. Thus, the fuel inside the first flow pipe CP1 will return to the fuel tank FT through the connecting passage 23b, and the fuel level in the first flow pipe CP1 will drop. In this way, on the basis of a differential pressure, fuel which has collected in the first flow pipe CP1 will be returned to the fuel tank FT without reaching the connecting part CP-J, thus avoiding outflow to the canister CS. Here, in the course of daily temperature changes, since nighttime temperatures are lower than daytime temperatures, fuel vapors in the fuel tank will become liquid and tank internal pressure will go to negative pressure in cyclical fashion. Owing to such cyclical negative pressure of tank internal pressure, any fuel that has collected in the first flow pipe CP1 will be reliably returned to the fuel tank FT.

The action of returning fuel that has collected in the first flow pipe CP1 to the fuel tank FT based on the aforementioned differential pressure will take place even if the first fuel cutoff valve 20 is not in the submersion state, or if the fuel level is such that the first fuel cutoff valve is shut.

(b) Second Submersion State

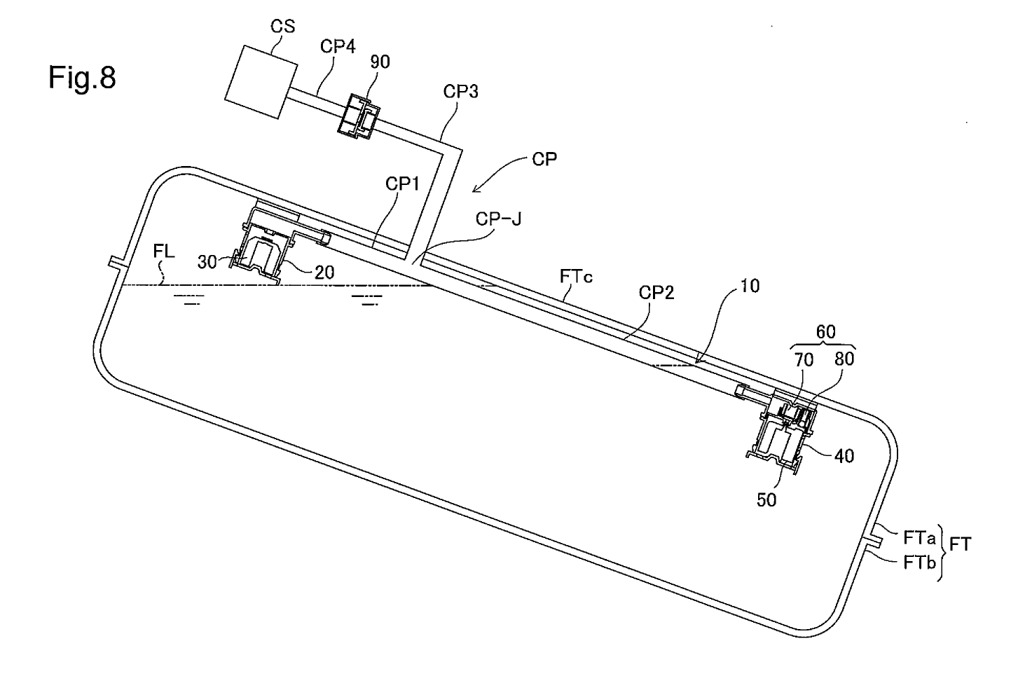

FIG. 8 depicts a second submersion state in which the second fuel cutoff valve 40 is submerged and the headspace of the fuel tank FT is in communication with the canister CS through the first fuel cutoff valve 20. In the second submersion state, since the fuel level FL in proximity to the second fuel cutoff valve 40 exceeds the prescribed level FL1 (FIG. 4), the second float mechanism 50 will be in the uplifted position, closing off the second connecting passage 43b. On the other hand, since the fuel level in proximity to the first fuel cutoff valve 20 does not exceed the prescribed level FL1 (FIG. 2), the first float mechanism 30 will be in the descended position and the first connecting passage 23b will be open. Venting and shutoff to the canister CS by the first fuel cutoff valve 20 will be ensured thereby. Because the second fuel cutoff valve 40 does not have higher sealing ability than the first fuel cutoff valve 20, in this instance more fuel will leak into the second flow pipe CP2 than in the first submersion state. However, with a full tank and the fuel tank FT tilted to the second maximum tilt angle, the connecting part CP-J will be positioned at a location above the fuel level in the fuel tank FT, and thus fuel leaking into the second flow pipe CP2 will not reach the connecting part CP-J and will not outflow to the canister CS.

(c) Return to Horizontal Attitude

Where fuel has collected in the first flow pipe CP1 or the second flow pipe CP2 which have assumed the first submersion state or the second submersion state, when the fuel tank FT returns to the horizontal attitude, since the first fuel cutoff valve 20 is open, the fuel which has collected in the first and second flow pipes CP1, CP2 will return to the fuel tank FT.

### (6) Effects and Advantages of the Embodiment

The embodiment described above affords the following effects and advantages.

(6)-1 Even where the vehicle has a full tank and has assumed a condition tilted as far as either the first or second maximum tilt angle, in the fuel tank ventilating device, either the first fuel cutoff valve 20 or the second fuel cutoff valve 40 will open so that venting of the fuel tank FT to the outside can be assured.

(6)-2 As the means for preventing outflow of fuel to the canister CS through the second flow pipe CP2 in the second submersion state with the second fuel cutoff valve 40 submerged as depicted in FIG. 8, the connecting part CP-J is disposed at a location whereby the second flow pipe CP2 is longer than the first flow pipe CP1, rather than the first flow pipe CP1 and the second flow pipe CP2 being of equal length. With this arrangement, even if the first flow pipe CP1 and the second flow pipe CP2 are routed on the horizontal, if the fuel tank FT should tilt, to the extent that the second flow pipe CP2 is longer it will be easier for the connecting part CP-J to be positioned above the fuel level in the fuel tank FT, that is, it will be easier to produce a pipe arrangement that inhibits outflow of fuel to the canister CS. Consequently, there will be no need for a complicated and elongated line or a line having a section which has been made higher through a bending process as described in the prior art, thus affording a simpler design.

(6)-3 An arrangement whereby the connecting part CP-J is disposed at a location such that the first flow pipe CP1 is shorter than the second flow pipe CP2 will, owing to the shorter length of the first flow pipe CP1, make it more difficult for the connecting part CP-J to be situated at a high position when the fuel tank FT is tilted; and will make it easier for leaked fuel to reach the connecting part CP-J where the first fuel cutoff valve CP1 is submerged; however, means such as the following can be adopted to avoid such problems. Specifically, as depicted in FIG. 7, firstly, the upper part valve body 32 of the first fuel cutoff valve 20 is made of rubber to enhance its sealing ability and reduce the amount of fuel leakage; and secondly, there is employed means adapted to return fuel that has collected in the first flow pipe back CP1 to the fuel tank FT by utilizing the differential pressure arising between pipe internal pressure in the first flow pipe CP1 and tank internal pressure caused by cyclical negative pressure of the tank internal pressure. Such avoidance means is simple in design, as it involves merely improving sealing ability of the first fuel cutoff valve 20 used conventionally, and appropriately setting the valve opening pressure for the positive pressure valve 70 and the positive/negative pressure valve 90.

### (7) Other Embodiments

The present invention is not limited to the embodiment set forth hereinabove, and may be reduced to practice in various other modes without departing from the scope of the invention, such as in the following possible modified embodiments for example.

(7)-1 While the preceding embodiment described an example in which the fuel cutoff device 10 of the fuel tank ventilating device is situated in the interior of the fuel tank, no limitation is implied thereby, and arrangements wherein device is instead situated on the top part of the fuel tank or protrudes partway into the fuel tank would be acceptable as well. An arrangement whereby the fuel cutoff device is mounted directly onto the top wall of the fuel tank would be acceptable, as would an arrangement whereby it is supported by a support member situated inside the tank.

(7)-2 While the fuel cutoff device 10 was described as having an arrangement with two valves, i.e. the first fuel cutoff valve 20 and the second fuel cutoff valve 40, disposed to either side of the fuel tank FT, no limitation is implied thereby, and three or more valves could be provided depending on the shape of the fuel tank FT.

(7)-3 While the first flow pipe CP1 and the second flow pipe CP2 differ in length due to the positioning of the connecting part CP-J, no limitation is implied thereby, and it would be acceptable to instead increase the pipe diameter of the first flow pipe CP1 or to provide a reservoir for example, to keep the amount of leakage from the first fuel cutoff valve 20 within a prescribed cycle to a lower level than the amount of fuel that can collect in the first flow pipe CP1.

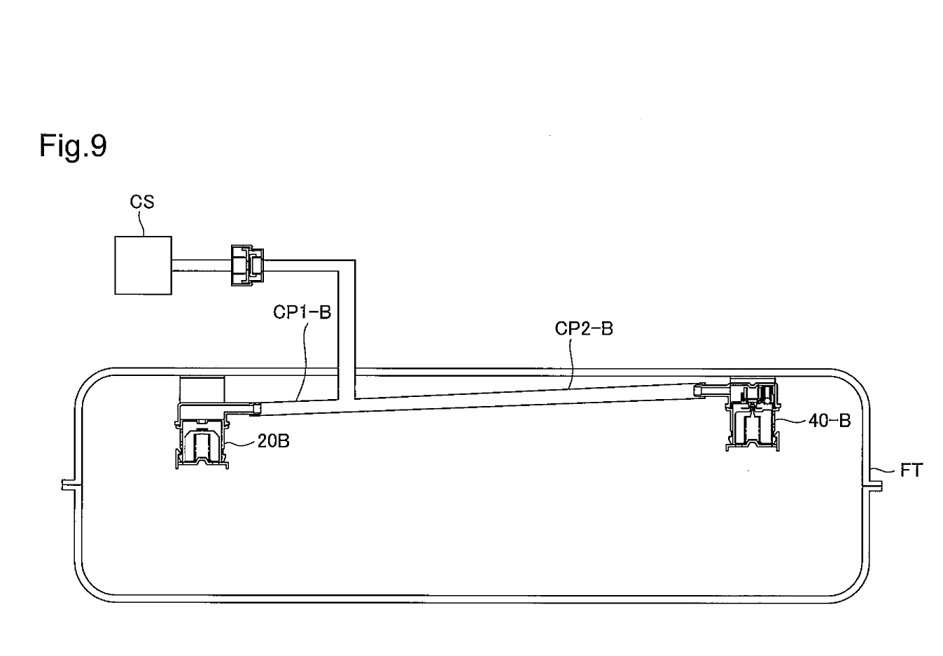

(7)-4 FIG. 9 shows a fuel tank FT having an installed fuel tank ventilation device according to another embodiment of the present invention. This embodiment involves a piping arrangement in which a first flow pipe CP1-B and a second flow pipe CP2-B are situated inclined by a prescribed angle with respect to the horizontal, specifically, with a first fuel cutoff valve 20B positioned below a second fuel cutoff valve 40B. According to this embodiment, fuel that has collected in a connecting pipe CP-B can be discharged more smoothly to the fuel tank FT by the first fuel cutoff valve 20B.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel tank ventilating device comprising: a fuel cutoff device for opening and closing a passage to a canister according to fuel level in a fuel tank; and a connector pipe connecting the fuel cutoff device with the canister, wherein
the fuel cutoff device includes:
(i) a first fuel cutoff valve adapted to open and close a first connecting passage through rise and fall of a first float mechanism according to the fuel level in the fuel tank;
(ii) a second fuel cutoff valve adapted to open and close a second connecting passage through rise and fall of a second float mechanism according to the fuel level in the fuel tank; and
(iii) a positive pressure valve connected to the second connecting passage and adapted to open when tank internal pressure rises above a prescribed valve opening pressure, wherein the first and second fuel cutoff valves are arranged to have a first submersion state and second submersion state when the fuel tank are oriented at a tilted position between a first maximum tilt angle and a second maximum tilt angle representing reverse maximum tilts respectively, wherein the first submersion state is a state in which the first fuel cutoff valve is submerged and the second fuel cutoff valve communicates a headspace of the fuel tank with the canister, and the second submersion state is a state in which the second fuel cutoff valve is submerged and the first fuel cutoff valve communicates the headspace of the fuel tank with the canister; and
the connector pipe includes:
(i) a first flow pipe connected to the first connecting passage;
(ii) a second flow pipe connected to the second connecting passage via the positive pressure valve and connected to the first flow pipe by a connecting part; and
(iii) a third flow pipe connecting the connecting part with the canister;
and wherein the fuel tank ventilating device is configured such that
when in the first submersion state, fuel that has flowed out from the fuel tank into the first flow pipe via the first fuel cutoff valve, the fuel is returned to the fuel tank by a differential pressure between a first pressure and a second pressure, the first pressure being a tank internal pressure which has been regulated to a level at or below the prescribed valve opening pressure of the positive pressure valve, the second pressure being a pipe internal pressure bearing on the fuel inside the first flow pipe; and
when in the second submersion state and at the second maximum tilt angle, fuel that has leaked from the fuel tank into the second flow pipe via the second fuel cutoff valve, the fuel does not reach the connecting part.

2. The fuel tank ventilating device in accordance with claim 1, wherein
the connecting part is situated at a location that is higher than the fuel level of the fuel tank at the second maximum tilt angle.

3. The fuel tank ventilating device in accordance with claim 1, wherein
the ventilating device has a first leakage amount and a second leakage amount, wherein
the first leakage amount is a value that indicates a leakage of fuel into the first flow pipe when the first connecting passage is closed off by the first float mechanism in the first submersion state, and
the second leakage amount is a value that indicates a leakage of fuel into the second flow pipe when the second connecting passage is closed off by the second float mechanism in the second submersion state, the first leakage amount being less than the second leakage amount.

4. The fuel tank ventilating device in accordance with claim 1, wherein
the connecting part is disposed at a location whereby the second flow pipe is longer than the first flow pipe.

5. The fuel tank ventilating device in accordance with claim 1, wherein the first fuel cutoff valve is positioned below the second fuel cutoff valve.

6. The fuel tank ventilating device in accordance with claim 1, wherein
the first flow pipe and the second flow pipe are inclined by a prescribed angle with respect to the horizontal.

7. The fuel tank ventilating device in accordance with claim 2, wherein
the ventilating device has a first leakage amount and a second leakage amount, wherein
the first leakage amount is a value that indicates a leakage of fuel into the first flow pipe when the first connecting passage is closed off by the first float mechanism in the first submersion state, and
the second leakage amount is a value that indicates a leakage of fuel into the second flow pipe when the second connecting passage is closed off by the second float mechanism in the second submersion state, the first leakage amount being less than the second leakage amount.

8. The fuel tank ventilating device in accordance with claim 7, wherein
the connecting part is disposed at a location whereby the second flow pipe is longer than the first flow pipe.

9. The fuel tank ventilating device in accordance with claim 2, wherein
the connecting part is disposed at a location whereby the second flow pipe is longer than the first flow pipe.
